(19) United States
(12) Patent Application Publication
(10) Pub. No.: US 2007/0227195 A1
(43) Pub. Date: Oct. 4, 2007

(54) Die For Producing Filaments, In Particular Glass Filaments And The Fibre Drawing System Thereof

(75) Inventors: Jean-Pierre Renaudin, Begon (FR); Andre Roger Richard, Le Risolet (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN VETROTEX FRANCE S.A., Chambery (FR)

(21) Appl. No.: 11/568,617

(22) PCT Filed: Apr. 7, 2005
(86) PCT No.: PCT/FR05/50217

§ 371 Date: Nov. 3, 2006

(30) Foreign Application Priority Data
May 14, 2004 (FR) 0405310

(51) Int. Cl. C03B 37/085

(52) U.S. Cl. 65/495

(57) ABSTRACT

A bushing for the manufacture of filaments, especially glass filaments including, on one of its faces a screen through which a molten material is intended to arrive via openings, and on its opposite face a bottom provided with plural orifices through which the molten material is intended to flow. A closure plate is attached and fastened to part of the total area of the screen.

The invention relates to a fiberizing installation that delivers filaments, especially glass filaments, and relates more particularly to one of the elements of the installation, namely the bushing.

Conventionally, a fiberizing installation comprises a flow block, which receives the molten glass coming from a channel connected to the furnace in which the glass is melted, a bushing block and a bushing. The bushing is provided in its upper part with a screen, which allows the flow of glass feeding said bushing to be distributed, and at the bottom with a plate provided with numerous orifices from which the molten glass flows out, to be attenuated as a multiplicity of filaments.

These filaments, the diameter of which may vary from 5 to 33 μm, are collected into at least one sheet that converges onto an assembling device in order to form at least one strand, for example, to be wound up. Depending on its use, the strand may also be chopped (to form chopped strands) or thrown onto a belt (to form continuous strand mats).

The products obtained are used mainly in various reinforcing applications.

In a manufacturing plant, a plurality of fiberizing installations are placed alongside one another. Upstream, the molten glass is output by a furnace and flows out through a main channel made of a refractory in order to be delivered, according to one standard configuration type, into two transverse channels in the manner of the bar of a T. This T bar is usually called the forehearth and the plurality of fiberizing installations is placed beneath its bottom.

The difficulty found in such a configuration, and therefore for such distribution, is the presence of a hot zone at the point where the hottest stream of the glass enters, i.e. at the intersection of the bar of the T, called the upstream portion of the forehearth, and therefore at the two first fiberizing installations placed on each side of this intersection; in contrast, at the ends of the bar of the T, on the two sides downstream of the forehearth, the stream of glass is coolest, the cooling being accentuated by the end wall of the channel of the forehearth.

The temperature of the glass entering each fiberizing installation is therefore different depending on the position of the fiberizing installation beneath the forehearth and depending on the geometric particularity of this forehearth.

Now, this thermal imbalance has an effect on the flow of glass that emanates from the bottom plate of the bushing of the fiberizing installation, and consequently modifies the titer of the filaments from one fiberizing installation to another, and even modifies the titer of two strands obtained at the same time by one and the same fiberizing installation (a difference of 5% may be observed).

Thus, this drawback makes the quality of the strand titer uncertain, sometimes causing the fiberizing process to be interrupted, and consequently time is wasted and material lost. This is manifested by a reduction in the quality of the products manufactured and an increase in the amount of scrap and therefore an increase in the production cost.

This thermal imbalance in the bushing may be corrected, to ensure uniform temperature over the bottom plate of the bushing, by adapting, by construction, the design of the forehearth and/or the flow block and/or the bushing block.

Document U.S. Pat. No. 6,044,666 for example discloses one particular arrangement inside the flow block, by the presence of walls forming a plurality of channels of different width, thus making it possible to deflect the main glass flow in order for it to be better mixed.

Another device for making the molten glass in the fiberizing installation follow a defined path, in order to ensure better temperature homogenization, is for example that disclosed in patent U.S. Pat. No. 5,928,402. Thus, the bushing is designed in a particular way that includes two spaced-apart screens that are placed above the bottom of the bushing, the screens being partly closed off at different points depending on the way they are arranged opposite each other. In this concept, the bushing has a height of about 4 cm, the height separating the bottom of the bushing from the higher screen of about 2.5 cm. This has the drawbacks of considerably increasing the quantity of precious metal or alloy constituting the bushing, of requiring more electrical power in order to heat it, and of increasing the head loss feeding the bottom of the bushing with glass.

Furthermore, these correction devices must be provided during the construction of the fiberizing installations in a plant, and therefore cannot be adapted to already existing installations since what has to be provided is either a well-defined flow block or a particular bushing having a height that does not fit with the standard dimensions.

In addition, several varieties of bushings and possibly bushing blocks must be available in order to replace any worn-out equipment, this also having a certain constructional complexity.

Finally, document Us 2003/205067 discloses a combination of two screens with the same area, the orifices of each of which face one another, the orifices of one screen, which is located above the other screen in the arrangement of a bushing, being of smaller diameter than the orifices of the lower screen.

However, this configuration requires the manufacture of a screen having the same area as the other screen, which goes counter to saving on materials, materials that are expensive to purchase. In addition, it is necessary to machine the screen at specific places and with particular orifice diameters, thereby complicating the construction of each of the screens.

The object of the invention is therefore to provide a simple means that is adaptable to any fiberizing installation already in existence, which can be used as an obstacle to the flow of the hot stream of molten glass in order to push it back toward the cool stream so as to obtain a temperature that is uniform over the entire bottom plate of the bushing via which the filaments are attenuated.

According to the invention, the bushing for the manufacture of filaments, especially glass filaments, comprising, on one of its faces, a screen through which a molten material, such as glass, is intended to arrive and, on its opposite face, a bottom provided with numerous orifices through which the molten material is intended to flow, is characterized in that it includes a closure plate attached and fastened to part of the surface of the screen at the point where the hottest stream of the molten material enters, this plate having a smaller area than the screen and having a shape matched to the shape of the hottest stream of the material.

The term “matched shape” is understood to mean a shape whose perimeter matches best the closed line defining the hottest region of the material but may not correspond strictly to this line.

Thus, the closure plate acts as a means of distributing the molten material, such as glass, in the bushing at the point where the hottest stream enters, so as to force this hotter glass to mix with the cooler glass in order to make the temperature of the glass in the bottom of the bushing uniform.

This plate, having an area matched to the hottest region of the flow of material, is thus of limited area, requiring for its manufacture only the appropriate amount of material.

Furthermore, the advantage of the device of the invention is that the plate is defined, cut to the desired dimensions and welded to the screen when the bushing is already completely constructed and packaged in its refractory. This construction therefore can be carried out before the bushing is fitted into that place of the forehearth for which it is intended. In general, the plate is positioned so as to be offset relative to the overall surface of the screen. For example, if the fiberizing installation is placed beneath a forehearth from which the glass flows out from the left to the right, the closure plate will be placed on the left-hand side of the bushing screen.

According to another feature, the plate is fastened to the upper face of the screen which is intended to receive the incoming flow of the molten material.

Preferably, the plate is fastened by welding around its periphery at discrete points. For example, it may be fastened by a plurality of spot welds, or else along at least two opposed lateral lines.

Advantageously, the plate may have a rectangular, oval or rhombic shape.

According to another feature, the plate has a thickness of between 0.2 and 0.5 mm, tailored with the corrective effects desired. It is made of the same metal or alloy as the bushing itself, in order to withstand being corroded by the molten material, particularly glass.

Finally, it is possible to envision the plate being a solid plate, or else pierced with orifices having diameters that differ from the openings in the bushing screen.

Further advantages and features of the invention will now be described in greater detail with regard to the appended drawings in which:

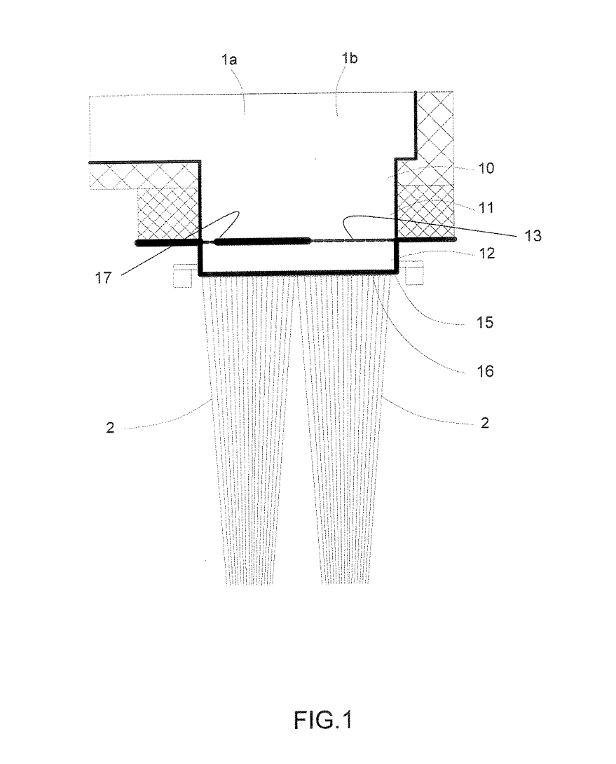

FIG. 1 is a sectional view of a fiberizing installation;

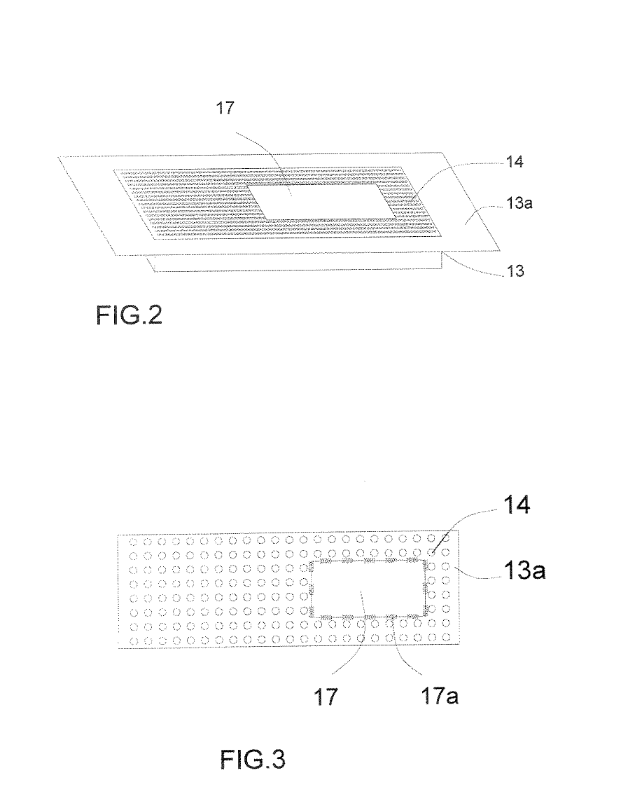

FIG. 2 is a perspective schematic view of the bushing according to the invention; and

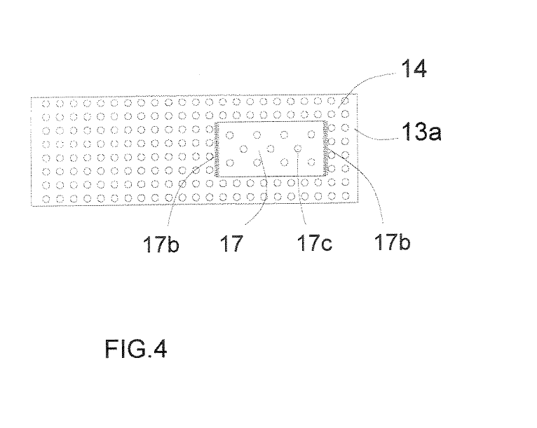

FIGS. 3 and 4 are top views of FIG. 2 in two alternative fastening and configurational embodiments.

FIG. 1 illustrates schematically a fiberizing installation 1 comprising a flow block 10, which receives molten glass 1a emanating from the forehearth 1b, a bushing block 11, through which the glass flows, and a bushing 12, into which the glass enters.

The bushing 12 has a height of about 50 mm. On its upper face, that is to say the point where the glass enters, it has a screen 13 provided with openings 14, this screen slowing the rate of flow of the glass delivered into the bushing. Furthermore, it includes, on its opposite face, a bottom plate 15 provided with a multitude of drilled orifices or teats 16 that extend over almost the entire area of the bottom plate and ensure that glass elements 2 are delivered.

FIG. 2 shows a detailed view of the upper portion of the bushing towards which the glass from the bushing block is intended to flow.

According to the invention, the screen 13 placed in the upper portion of the bushing is provided on its external face 13a with a plate 17 that is attached and fastened to part of the surface of the screen in order to close off some of the openings 14.

This closure plate is made of the same material as that of the bushing, namely platinum or platinum alloyed with rhodium. It has a thickness of between 0.2 and 0.5 mm.

Its area, its shape and the place where it is positioned relative to the overall surface of the screen 13 depend on the point at which the hottest region of the flow of molten material lies. This is because it is at this point that the plate has to be positioned in order to deflect the hottest glass toward the coolest glass so as to make the final temperature of the glass flowing through the teats 16 uniform.

The plate 17 has a shape whose outline is best matched to the closed line defining the hottest glass flow region.

The plate 17 may be a solid plate (FIG. 3) or may be drilled with orifices 17c having diameters that differ from the orifices 14 in the bushing screen (FIG. 4).

It may have various shapes that are matched to the shape of the hottest glass flow, namely rectangular, oval, rhombic, etc.

The plate 17 is fastened to the screen by welding around its periphery at discrete points, either at several spots 17a (FIG. 3) or along portions of lines 17b (FIG. 4) and preferably along two opposed sides.

Thus, when a disparity is observed in the titer of the filaments from one or more fiberizing installations in a manufacturing plant, it is necessary to determine the hottest flow regions in the bushings by studying the hydraulic and thermal head loss taking into account the viscosity of the glass, and to then match the shape, size and position of the closure plate 17 to be fastened to the bushing screen 13.

For example, a variation of 2 to 5% in absolute value of the titer of four strands delivered by four respective regions of the same die has been observed, these regions, which are in line from the left to the right, being termed left, center-left, center-right and right, and the glass entering the bushing from the left of the forehearth. After adding the plate 17, this variation in the titer could be corrected, not exceeding 1%.

The table below summarizes the percentage deviation relative to the nominal titer, with and without the plate.

| | Left | Center-left | Center-right | Right |
|---|---|---|---|---|
| No plate | −5% | −3% | +2% | +4% |
| With plate | −1% | −0.5% | 0% | +0.3% |

1-11. (canceled)

12: A bushing for manufacture of filaments, comprising:
a screen on a first of the bushing face, through which a molten material is intended to arrive via openings;
a bottom on a second face opposite to the first face, the bottom provided with plural orifices through which the molten material is intended to flow; and
a closure plate attached and fastened to part of the surface of the screen at a point where a hottest stream of the molten material enters, the plate having a smaller area than the screen and having a shape matched to a shape of the hottest stream of the material.

13: The bushing as claimed in claim 12, wherein the plate is positioned to be offset relative to the overall surface of the screen.

14: The bushing as claimed in claim 12, wherein the plate is fastened to the first face of the screen which is intended to receive the incoming flow of the molten material.

15: The bushing as claimed in claim 12, wherein the plate is fastened at its periphery by welding at discrete points.

16: The bushing as claimed in claim 15, wherein the plate is fastened by a plurality of spot welds.

17: The bushing as claimed in claim 15, wherein the plate is fastened along at least two opposed lateral lines.

18: The bushing as claimed in claim 12, wherein the plate has a rectangular or oval or rhombic shape.

19: The bushing as claimed in claim 12, wherein the plate has a thickness of between 0.2 and 0.5 mm.

20: The bushing as claimed in claim 12, wherein the plate is made up of a same metal or alloy as that of the bushing.

21: The bushing as claimed in claim 12, wherein the plate is a solid plate or is pierced by orifices having diameters that differ from the openings in the screen.

22: A fiberizing installation that includes a bushing as claimed in claim 12.
